(19) United States
(12) Patent Application Publication
(10) Pub. No.: US 2011/0202532 A1
(43) Pub. Date: Aug. 18, 2011

(54) INFORMATION SHARING SYSTEM, INFORMATION SHARING METHOD, AND INFORMATION SHARING PROGRAM

(75) Inventors: Satoshi Nakazawa, Tokyo (JP); Takahiro Ikeda, Tokyo (JP); Yoshihiro Ikeda, Chiba (JP); Kunihiko Sadamasa, Tokyo (JP); Takao Kawai, Tokyo (JP)

(73) Assignee: NEC CORPORATION, Tokyo (JP)

(21) Appl. No.: 12/674,470

(22) PCT Filed: Aug. 8, 2008
(86) PCT No.: PCT/JP2008/064360

§ 371 Date: Feb. 26, 2010

(30) Foreign Application Priority Data
Aug. 21, 2007 (JP) 2007-214489

(51) Int. Cl. G06F 17/30

(52) U.S. Cl. 707/738; 707/E17.089

(57) ABSTRACT

There has been a problem in a related art that as information of a certain topic is scattered, the information cannot be shared efficiently,. An information sharing system includes a specified section linguistic analysis element that performs a linguistic analysis to a specified section text and outputs linguistic analysis information, a specified section topic generation element that generates topic information from the linguistic analysis information, where the topic information is a topic of the specified section text, and a bulletin board management element that refers to a bulletin board information storage unit and if address information of a bulletin board corresponding to the topic information is obtained, outputs the address information or a set of the topic information and the address information as corresponding bulletin board information.

### TECHNICAL FIELD

The present invention relates to an information sharing system, an information sharing method, and an information program, and particularly to a technique for sharing information of the same topic.

### BACKGROUND ART

There are several techniques for sharing information of the same topic, for computerized information such as information described on a Web page. The “topic” here refers to a central topic and a theme of a certain text.

As an example of the techniques for sharing the information of a certain topic, there are a comment function (related art 1) in a blog and an electronic bulletin board (related art 2. Hereinafter referred to as a “bulletin board”)

The related art 1 is a function to enable a viewer of a blog to post a feedback and a comment after reading an original article to a page of the original blog. Another viewer who read the blog later on can also read the posted comment in addition to the original article, so that the viewer can obtain the feedback of other viewers who read the same blog page and additional information, in addition to the information of the original blog page. Further, viewers can argue or exchange opinions through the comment field.

In the related art 2, a user adds new information to a thread (a page provided for each topic that includes a bulletin board function). A user can newly create a thread at will. This technique enables to provide a place for opinion exchange between users. Further, a bulletin board is effective as a referential function since there is much information added to one thread and thereby enabling to efficiently refer to the information to the topic.

### SUMMARY OF THE INVENTION

### Technical Problem

There is a problem in the related arts that the information on a certain topic is scattered and the information cannot be efficiently shared.

In the related art 1, viewers of a blog can share information. However, a blog basically transmits information that links an information transmitter (blog creator). As there are many information transmitter independently transmitting information of various topics on the Web, many pages dealing with the same or similar topic exist that are independently created. Even if the viewer who has viewed one of the pages adds a valuable comment to the blog, viewers of a blog that deal with a similar topic cannot notice the existence of the comment.

On the other hand, the related art 2 links threads, not the information transmitter, and is an information sharing tool suited for addition of information and discussion on the topic. When adding information to a certain topic, if everybody adds to a particular thread in a particular bulletin board, the information will not be scattered.

However, since a thread can be created with any topic, the thread and the topic are not necessarily unique. Accordingly, there is a problem existing that multiple threads exist for similar topics and it is not clear which thread to refer to.

Further, not everybody necessarily adds information to a particular bulletin board. For example, it is needless to say that a person who is unaware of the existence of the bulletin board cannot use the bulletin board. Moreover, as the viewers of the blog or the like can add new information to a page of the blog using the related art 1 while viewing the blog, it is quite unlikely that the viewers search for a thread relating to the topic that interests the viewers from the bulletin board in order to add information.

The present invention is made to solve such problem, and aims to provide an information sharing apparatus, an information sharing system, an information sharing method, and an information sharing program that share information for a certain topic more efficiently.

### Technical Solution

An information sharing system according to the present invention includes a specified section linguistic analysis means that performs a linguistic analysis to a specified section text and outputs linguistic analysis information, a specified section topic generation means that generates topic information from the linguistic analysis information, where the topic information is a topic of the specified section text, and a bulletin board management means that refers to a bulletin board information storage unit and if address information of a bulletin board corresponding to the topic information is obtained, outputs the address information or a set of the topic information and the address information as corresponding bulletin board information.

### Advantageous Effects

The effect of the present invention is that the information of the same topic can be shared more efficiently.

The reason for that is that the specified section linguistic analysis means performs a linguistic analysis of the specified text section, the specified section generation unit generates topic information corresponding to a linguistic analysis result, and if the bulletin board of the generated topic information already exists, the bulletin board management means notifies an address thereof to a user.

Therefore, as a user who is viewing a page, such as a blog, other than the bulletin board can know the existence of the bulletin board that relates to the content currently being viewed, it is possible to lead the user to add new information to the bulletin board. Further, a user who does not add information can also obtain more information by referring to the bulletin board.

Moreover, by performing a linguistic analysis, slightly different expressions can be recognized as the same topic information to associate threads, and the topic and the thread can be specified uniquely, thereby enabling to share information of the same topic more efficiently.

### BEST MODE FOR CARRYING OUT THE INVENTION

Next, the best mode for carrying out the present invention is described in detail with reference to the drawings and examples.

### First Embodiment

Referring to FIG. 1, a first embodiment of the present invention is composed of a processing apparatus 10 and a storage apparatus 20. The processing apparatus 10 is provided with a document browser means 11, a user specified section input means 12 that specifies a text section that a user wishes to register from a document currently being viewed, a specified section linguistic analysis means 13 for performing a linguistic analysis of the text section specified by the user, a specified section topic generation means 14a that receives a linguistic analysis result of the specified text section and generates topic information according to the linguistic analysis result of the section, a bulletin board management means 15a that determines whether a bulletin board of the generated topic information already exists in a bulletin board information storage unit 23 and outputs as corresponding bulletin board information, and a corresponding bulletin board information output means 16 that displays the corresponding bulletin board information on the document browser means 11. Further, the storage apparatus 20 is composed of a document information storage unit 21, a dictionary storage unit for linguistic analysis 22, and a bulletin board information storage unit 23 that stores information of the bulletin board for each topic information. The dictionary storage unit for linguistic analysis 22 is provided with a word dictionary storage unit 221 used for linguistic analysis, and a synonymous expression dictionary storage unit 222 which stores words that are equated at the time of linguistic analysis and expressions formed of multiple words. The bulletin board information storage unit 23 is provided with an address information storage unit 231 that stores information such as an address of the bulletin board corresponding to each topic information, and a comment information storage unit 232 that stores comment information corresponding to each topic information. The information stored in the address information storage unit 231 and the comment information storage unit 232 may be collectively stored.

Note that the “topic information” here indicates an ID of a bulletin board that specifies one particular bulletin board from the information of bulletin boards stored in the bulletin board information storage unit 23 described later on. As it is the ID of the bulletin board, if the topic information differs, it indicates a different bulletin board, and conversely, if the bulletin boards are the same, the topic information is certainly the same.

The document browser means 11 is a browser for a user to view documents, such as a Web document and an office document. As long as the function for viewing documents is included, it may be an editor such as a word processor provided with an editing function, or a document viewer embedded in other application. The document viewed by a user is not limited to text but may be a multimedia document published on the WWW such as video and still image or the like. However, the document must be provided with a function that receives a text section in the document currently being viewed and an address to the bulletin board corresponding to the text section, and accesses the corresponding bulletin board. The received address to the bulletin board may be embedded and displayed as a hyperlink in the corresponding text section. Further, the received bulletin board address may be collectively displayed at the end of the document or a page break, etc. Moreover, a function may be provided, in which not only the address to the bulletin board but all or a part of the comments stored in each bulletin board have different display method such as font or indent to distinguish from the document to view so as to be output, so that users can view the content of the comment without accessing the bulletin board itself.

The user specified section input means 12 is an input interface for a user to specify an arbitrary text section included in the document viewed by the user using the document browser means 11. As for a specification method of the text section, it may be any method as long as it is a range specification method of a text usually used by an internet browser or a word processor etc. For example, the method may be, specifying a start and an end of the text section using a mouse, highlighting with a cursor, or taking a section delimited by text structure such as a sentence, paragraph, and chapter in the text section including a certain point in a document specified by the user. The specified section text specified by the user specified section input means 12 is output to the specified section linguistic analysis means 13 described later on.

The specified section linguistic analysis means 13 is a module that refers to the dictionary storage unit for linguistic analysis 22 described later, performs a linguistic analysis of the input specified section text, and outputs linguistic analysis information. As a result of the linguistic analysis, the input specified section text is converted into a linguistic expression form indicating the semantic content of the text. The linguistic expression form to choose depends on what kind of linguistic analysis technique to use for the specified section text. Accordingly, the linguistic analysis technique according to the usage and the purpose at the time of carrying out the present invention is mounted in this module. As an example of possible linguistic analysis techniques and the linguistic expression forms, which are the results thereof, the combination as illustrated in FIG. 2 can be considered. The example mentioned in FIG. 2 is existing natural language processing techniques. Further, although there are fields describing multiple techniques in the linguistic analysis technique, it is not necessary to use all of them, but one or more of them may be used as appropriate.

For example, when using the dependency analysis, the text section such as “actual performance and market channel of the health food A” can be a linguistic expression form such as “health food A→actual performance, health food A→market channel”.

Further, 5W1H elements such as “when” “where” “who” “what” “why” “how” can be extracted from the specified section text as the linguistic expression form indicating the semantic content of the text. The named entity recognition can be used for this purpose. For example, from the text such as “increasing trend of the number of infants and toddlers in recent years in Yokohama city is shown below for expenditure analysis”, 5W1H elements such as “when→recent years” “where→Yokohama city” “what→increasing trend of the number of infants and toddlers” “how→shown” are extracted.

Further, as for the linguistic analysis process performed by the specified section linguistic analysis means 13, if the information included in the input specified section text is insufficient, more texts may be extracted from before and after the specified section text in the original document in order to perform the linguistic analysis process in addition to the input specified section text. At the time of extracting the elements of 5W1H “when” “who” or the like, property information added to the original document may be read out, not only the specified section text, so as to extract those elements from the date and time of creation or the creator of the document.

The specified section topic generation means 14a receives the linguistic analysis information generated by the specified section linguistic analysis means 13 and generates topic information based on the information.

Upon carrying out the present invention, if the topic information is used only as a bulletin board ID that specifies one bulletin board from multiple bulletin boards managed by the bulletin board information storage unit 23, the linguistic analysis information is used as the topic information as is. However, when using the topic information as a name of the bulletin board to be presented to users, the readability is low for the linguistic analysis information as is, which is the linguistic expression form, thus the linguistic expression is converted into a text expression written in the natural language again, so as to generate the conversion result as the topic information. The conversion from the language expression into the natural language form uses the technique of text synthesis used by the machine translation etc. For example, “game machine P→sale, a game machine W→recall” which were written in the relationship between two items of words, can be synthesized as in “sale of a game machine P, and recall of a game machine W.” As a result of the text synthesis, if there is a possibility that the uniqueness as a bulletin board ID of the topic information may be lost, it can be used as a set such that the linguistic expression before the text synthesis may be used as the ID specifying the bulletin board, and a text synthesis result may be the title of the bulletin board presented to a user.

Moreover, although the topic information itself is an ID that specifies a bulletin board uniquely, multiple topic information may be generated from one linguistic analysis information. In that case, since several different bulletin boards correspond to the specified section text specified by a user, the bulletin board address output means for specified section described later also returns addresses of the multiple bulletin boards. If a user registers and views a comment, the bulletin board to register and view the comment will be selected separately, or the comment will be registered and viewed to all the bulletin boards. For example, if multiple parallel linguistic expressions like “game machine P→sale and game machine W→recall” are received, the topic information may be specified using an AND condition such as “game machine P→sale & game machine W→recall”, or it may be divided into two topic information, “game machine P→sale” and “game machine W→recall”. The method to divide and generate the topic information is previously determined according to the usage and the purpose at the time of carrying out the present invention.

As for each of topic information generated by the specified section topic generation means 14a, the bulletin board management means 15a determines whether there is existing matching topic information exists in the bulletin board information storage unit 23.

If the existing bulletin board having the matching topic information exists, the address to the bulletin board indicated by the topic information is made into a set with the information indicating which specified section text that the topic information is obtained therefrom, and then output as corresponding bulletin board information.

If there is no existing bulletin board that matches the topic information, firstly a bulletin board having the topic information is newly created in the bulletin board information storage unit 23, then the information indicating which of the specified section text that the address to the newly created bulletin board is obtained therefrom is made into a set with the bulletin board, so as to output as the corresponding bulletin board information. The address to the bulletin board is an address providing an interface service or the like for accessing to the bulletin board, such as an http address.

Note that it is not necessary to newly create the bulletin board of the topic information. The information that “the bulletin board does not exist” may be output as the corresponding bulletin board information.

The bulletin board management means 15a may be operated so that the contents of the document viewed by the user can be displayed on the bulletin board. Specifically, there are forms such as the text information near the specified section input by the user specified section input means 12 or the address information such as http of a document that the user is viewing by the document browser means 11 is added to the comment information storage unit 820 that stores comments to the bulletin board of the corresponding topic information. It is needless to say that it is not limited to this mode. Accordingly, the user is able to know the description content of other documents written for the same topic only by viewing the bulletin board.

The corresponding bulletin board information output unit 16 makes up a set of the specified section text and the address to the corresponding bulletin board from the bulletin board management unit 15a, and returns the set to the document browser means 11 as the corresponding bulletin board information. As a method to return, information of the address may be directly passed or the information of the address may be embedded in a file of a document.

The document browser means 11 refers to the corresponding bulletin board information output by the corresponding bulletin board information output unit 16, and displays the address of the bulletin board corresponding to the specified section text. The bulletin board information may be the form in which the information of the address is directly passed or the information of the address may be embedded in a file of a document. Further, the display method of a document browser may be, providing a link to the bulletin board in the specified section text part, or the address of the bulletin board is displayed as text information. Moreover, if the bulletin board does not exist, indicate that there is no corresponding bulletin board by displaying that the bulletin board does not exist or not outputting anything to the specified section text.

The document information storage unit 21 is a storage unit that stores the information of the document viewed by the user. The document information storage unit 21 is connected to the document browser means 11 on the Internet, thus the user can view the information stored in the document information storage unit 21 through the document browser means 11.

The dictionary storage unit for linguistic analysis 22 stores dictionary data for the specified section linguistic analysis means 13 to refer to at the time of performing a linguistic analysis, and is provided with a word dictionary storage unit 221 and a synonymous expression dictionary storage unit 222.

The word dictionary storage unit 221 is a dictionary for words used by the specified section text analysis means 13 to perform a linguistic analysis to the specified section text. In the dictionary of each word, the information necessary for the linguistic analysis process in the specified section linguistic analysis means 13 is stored among dictionary information used in general natural language processing techniques, such as grammar information including notation of a word, word delimiter, word class and conjugation, grammar information indicating a method of connection between words, statistical information, information of a stop word indicating whether each word is important for usage and purpose upon carrying out the present invention, and dictionary information used in general natural language processing techniques.

The synonymous expression dictionary storage unit 222 is a dictionary describing words to be equated or collections of multiple words combinations in the linguistic analysis process by the specified section linguistic analysis means 13. Upon the linguistic analysis process, the synonymous expression dictionary storage unit 222 is used to uniformly process fluctuation of notation for the words with the same meaning such as “Internet” and “Internet” or similar expressions such as “attend the school” and “go to school”. As with the word dictionary storage unit 221, such synonymous expression dictionary storage unit 222 is one of the existing natural language processing techniques, and not mentioned in detail in this document. The kind of word collections or collections of combinations of words that are registered in the synonymous expression dictionary storage unit 222 differ depending on to the usage and the purpose at the time of carrying out the present invention. At the time of generating the topic information specifying the bulletin board by the specified section topic generation means 14a, words wishing to be equated and a set of a combination of words are registered.

The bulletin board information storage unit 23 is a database which stores the information of the bulletin board. The bulletin board information storage unit 23 is composed of an address information storage unit 231 which stores the information for each title of the bulletin board, and a comment information storage unit 820 registered for each bulletin board. The function of the bulletin board is the same as that of the common bulletin board widely used on the WWW etc. In addition to the comment itself, the comment information storage unit holds the information of the document used as the basis of the comment registration, and the information of the specified section text. Moreover, the comment information storage unit may hold the date and time of the comment registration and the information of a comment resistant. The information of the document used as the basis of the comment registration may be held in the form of the information indicating the storage location of the document or the accessing method such as an http address, or a copy of the document itself may be held in case the original document is modified or deleted.

The above configuration is the configuration of the first embodiment of the present invention.

Moreover, in this embodiment, each component mentioned in the processing apparatus 10 of FIG. 1 may be provided via a recording media that is machine readable such as CD-ROM or a network including the internet, as a program for controlling each function, and read by a computer or the like to be executed.

Next, an operation of this embodiment is explained with reference to the flowchart of FIG. 3.

FIG. 3 is a flowchart illustrating an output operation of bulletin board address for user specified section in the information sharing apparatus according to the first embodiment of the present invention.

According to FIG. 3, the user specified section input means 12 receives the specified section text specified by the user from the document displayed by the document means 11 (step A1).

Subsequently, the specified section linguistic analysis means 13 refers to the dictionary storage unit for linguistic analysis 22 to perform a linguistic analysis of the received specified section text, and outputs linguistic analysis information, which is a linguistic expression corresponding to the specified section text (step A2).

Next, the specified section topic generation means 14a generates the topic information which is a topic corresponding to the specified section text from the linguistic analysis information (step A3).

If the topic information is generated, the bulletin board management means 15a confirms whether the bulletin board corresponding to the topic information exists in the bulletin board information storage unit 23, and if exists, the process proceeds to step A51 and if it does not exist, proceeds to step A52 (step A4).

If the existing bulletin board corresponding to the generated topic information exists, the topic information and the address information of the existing bulletin board are made into a set to be output as corresponding bulletin board information (step A51).

If the existing bulletin board corresponding to the generated topic information does not exist, a bulletin board of the new topic information is created in the bulletin board information storage unit 23, and the topic information and the address information of this bulletin board is made into a set to be output as the corresponding bulletin board information. Alternatively, the bulletin board is not created and the information that the bulletin board does not exist is output as the corresponding bulletin board information (step A52).

If there is two or more topic information generated in the step A3, the procedure from the step A4 to the step A51 or A52 is performed to each topic information.

Then, the corresponding bulletin board information output means 16 outputs the corresponding bulletin board information to the document browser means 11 (step A6).

Lastly, the address of the bulletin board is output via the original document browser means by the output form depending on the usage and the purpose at the time of carrying out the present invention (step A7).

The effect in this embodiment is the point that the information on the same topic can be shared more efficiently. As the user who is viewing a page other than the bulletin board such as blog can know that there is the bulletin board relating to the content currently being viewed, it is possible to lead the user to add new information to the bulletin board. Furthermore, the user who does not add information can also obtain more information by referring to the bulletin board.

Moreover, by performing a linguistic analysis, slightly different expressions can be recognized as the same topic information to associate threads, thus the topic and the thread can be specified uniquely, so that the information of the same topic can be shared more efficiently.

For example, in the service called “hatena keyword” or “hatena diary keyword” (related art 3, non patent literature 1), if a string matching “hatena keyword” is included in the texts of the blog called “hatena diary”, the string part in the blog is automatically underlined, and a link is embedded to the page describing the definition of the word in the “hatena keyword” system. However, in the related art 3, if two blogs dealing with a similar topic do not commonly include a string that is already registered as a keyword, viewers of one blog cannot notice the other.

### Citation List

### Non Patent Literature 1

Hatena keyword. Searched on 20 Jul. 2007. <http://d.hatena.ne.jp/keyword/>.

On the other hand, in this embodiment, even when completely same strings are not included, it can be recognized as the same topic, thus enabling to share the information of the same topic more efficiently.

### Second Embodiment

The configuration of a second embodiment of the present invention is explained with reference to FIG. 4.

In addition to the mode of the first embodiment, the information sharing apparatus according to the second embodiment of the present invention includes a topic generation policy storage unit 24. In connection with it, there is a different point in the specified section topic generation means 14b from the specified section topic generation means 14a in the first embodiment. Other configurations are same to that of the first embodiment, thus the explanation is omitted.

The specified section topic generation means 14b receives a linguistic expression which is a linguistic analysis process result of the specified section text, and generates the topic information in accordance with the rule for topic generation stored in the topic generation policy storage unit 24. The specified section topic generation means 14b confirms whether each rule (policy) stored in the topic generation policy storage unit 24 can be applied to the received linguistic expression, and if it is applicable, a linguistic expression is rewritten in accordance with the rule.

The topic generation policy storage unit 24 is a database that stores rules for converting the linguistic expression into the topic information in the specified section topic generation means 14b. Specifically, detailed information that is not desirably distinguished as the topic information may be included in the linguistic expression obtained as a result of the linguistic analysis of the specified section text by the specified section linguistic analysis means 13, thus the topic generation policy storage unit 24 stores rules for deleting such detailed information to degenerate as the topic information. The information of the linguistic expression to delete differs depending on the usage and the purpose at the time of carrying out the present invention.

As an example of a kind of the rule, there is a dependency expression. When using the dependency expression between words as a linguistic expression, if the direction of the dependence is not distinguished, a rule for deleting the information indicating the directional property of the dependency from the linguistic expression is stored.

Moreover, there are also the rules concerning the classification of tense, modality, and tense expression. Whether or not to classify the tense information such as “did” and “will do” can be specified.

In addition, there is a level of information and deletion of information or the like to the information including 5W1H etc. Even when the location information and time information as 5W1H information is extracted from the specified section text to be a linguistic expression, if the bulletin board does not need to be classified by time or location, the rule for deleting the elements of the information that do not need to be classified is stored.

Moreover, there is a display method of the topic information. It may be a notation in the natural language that is easily readable for users, or a linguistic expression such as a dependency structure of words or a partial tree of a parse tree. The topic information to generate may only be able to uniquely identify a bulletin board. Note that unlike the notation in the natural language, linguistic expressions, such as dependency structure of words and a partial tree of a parse tree, are not usually readable for people. However, the topic information to generate may only be able to uniquely identify a bulletin board, thus there is no problem to use such linguistic expression as the topic information as is.

It is needless to say that the kind of rules is not limited to the above examples but may be specified as appropriate.

It can be said that the process to generate the topic information from the specified section text through the specified section linguistic analysis means 13 and the specified section topic generation means 14b is to make a summary of the original specified section text. If the topic information generated is the same for specified section texts that have different notations, a common bulletin board in the bulletin board stored in the bulletin board information storage unit 23 corresponds to those different specified section texts. However, unlike a normal text abstract technique, the readability of the topic information may not be necessarily high for users. Moreover, a difference from the text summarization technique is that unless the point is not to be emphasized at the time of sharing comment information, it can be eliminated when generating the topic information even if the point is included in the original specified section text.

Next, an operation of this embodiment is explained with reference to the flowchart of FIG. 5.

The different point of FIG. 5 from FIG. 3 according to the first embodiment is that the step A3 is step B3. Other operations are same as FIG. 3, thus the explanation is omitted.

In the step B3, the specified section topic generation means 14b generates the topic information corresponding to the specified section text from the linguistic expression of the specified section text using the rule stored in the topic generation policy storage unit 24.

The effect in this embodiment is the point that the degree of detail, classification, and display method of the topic information can be specified according to the usage and the purpose of information sharing. This enables information sharing that suits the purpose of the bulletin board service provider.

Furthermore, there is an effect that it is easier for the users of the bulletin board to find a bulletin board with the topic relating to the interesting content. The reason for that is that the level of degree of detail is unified at the time of generating the topic information. For example, as the texts of “track and field competition on June 11” and “track and field competition in the second week of June” generate the same topic information, it is possible to lead users who viewed articles with different expressions to the same bulletin board.

### Third Embodiment

The configuration of a third embodiment of the present invention is explained with reference to FIG. 6.

Referring to FIG. 6, as compared with the configuration of the first embodiment, the third embodiment of the present invention is different in the configuration in the point that a document section division means 17 is included instead of the user specified section input means 12. Only the document section division means 17 and the bulletin board management means 15b with a different operation point are described here.

The document section division means 110 receives a document from the document browser means 11, and divides the text included therein into multiple text sections. The division may be performed according to document structures, such as a sentence or chapter, or delimited by words or expressions previously specified according to the usage and the purpose at the time of carrying out the present invention. Moreover, each of the divided text section may be overlapped as long as it does not completely match another text section. Then, each of the divided text section is transmitted to the specified section linguistic analysis means 13, and then a linguistic analysis process is carried out in a similar way as the specified section text explicitly specified by a user using the specified section input means 12, and as a result, a bulletin board address corresponding to each specified section text is output from the bulletin board management means 15b.

The function of the bulletin board management means 15b is the same as the function of the bulletin board management means 15a according to the first embodiment of the present invention except for an operation of confirming whether there is an unprocessed divided text to sequentially perform processes for each text.

However, in the case of this embodiment, if the bulletin board to each topic information does not exist, it is desirable that instead of creating a new corresponding bulletin board, the information that there is no corresponding bulletin board is to be the corresponding bulletin board information. The reason for that is that if a new bulletin board is created when there is no bulletin board with the same topic information for all the document content, many useless bulletin boards are created.

The above configuration is the configuration of the third embodiment of the present invention.

Next, an operation in the third embodiment of the present invention is explained along the flowchart of FIG. 7.

According to FIG. 7, the document section division means 17 reads the document to be processed from the document browser means 11, and divides into multiple text sections (step C1). Next, one of the divided text sections is output as a specified section text (step C2).

Since the step A2 to step A51 or A52 are the same as the operation of the first embodiment, the explanation is omitted.

After the step A51 or A52, confirm whether there is an unprocessed item in the text section divided in step C1, and if there is an unprocessed item, the process returns to the step C2 in order to perform a linguistic analysis to the unprocessed text section (step C3). If the process to all the text sections is completed, the process proceeds to step C4.

Lastly, all the corresponding bulletin board information output in the step C4 is output via the original document browser means in the output form according to the usage and the purpose at the time of carrying out the present invention (step C5).

Then the operation according to the third embodiment of the present invention is completed.

The effect in this embodiment is the point that as the text included in a document is divided to determine whether there is a bulletin board existing that corresponds with each text, a user can know the existence of the bulletin board without specifying a particular section.

Note that this embodiment may be combined with the second embodiment. In that case, in FIG. 6, the specified section topic generation means 14a is to be the specified section topic generation means 14b, and further provided with the topic generation policy storage unit 24. The operation of each configuration is as described in the second embodiment.

### EXAMPLE 1

An example in the first embodiment is described with reference to FIG. 8.

A user views a blog 1 of FIG. 8 by the document browser means 11. If the user is interested in the description of “playing SACD on the game machine P” in the blog, the specified section text of the description is specified using a mouse.

Next, the specified section linguistic analysis means 13 performs a linguistic analysis to the specified section. This example uses the dependency analysis technique. As the result, a linguistic analysis result of “game machine P→play” and “SACD→play” are output.

Moreover, the specified section topic generation means 14 uses the technique of text synthesis, which is used by machine translation etc., and generates topic information from the output result of the specified section linguistic analysis means 13. In this example, the topic information “playing SACD on the game machine P” is generated.

The bulletin board management means 15a determines whether there is existing topic information that matches the generated topic information “playing SACD on the game machine P”. If the existing topic information that matches the topic information exists, information indicating which specified section text to have obtained an address to the bulletin board indicated by the topic information therefrom is made into a set with the topic information to be output as the corresponding bulletin board information. If there is no existing bulletin board having the matching topic information in the bulletin board information storage unit 23, a bulletin board having the topic information is newly created in the bulletin board information storage unit 23, then an address to the newly created bulletin board and the information indicating which specified section text to have obtained therefrom is made into a set to be output as the corresponding bulletin board information. The corresponding bulletin board information is displayed on the document browser means 11 through the corresponding bulletin board information output means 16.

By providing a link to the text part of “playing SACD on the game machine P” as illustrated in FIG. 8, the user can know the existence of the bulletin board having the topic information of “playing SACD on the game machine P” and an address of the bulletin board. By viewing the bulletin board based on the information, more information can be obtained about an interested topic. Moreover, by adding a comment to a common bulletin board not to the page firstly viewed, more efficient information sharing can be made possible.

### EXAMPLE 2

An example in the second embodiment is described.

The topic generation policy storage unit 24 stores a degree of detail, classification, and rules necessary to specify the display method for the topic information to generate. As an example, 5 rules are explained.

The first rule concerns the classification of modality and tense expression. For example, if a syntactic analysis is carried out to the text and obtained syntactic analysis result is used as a linguistic expression, modality and tense expression in the text are usually stored in parse trees as information. As a result, the linguistic expressions to the following texts differs, which are “I want to purchase the game machine P” “I heard that the is going to purchase the game machine P” “I will purchase the game machine P” “I purchased the game machine P” “I am going to purchase the game machine P” “I might purchase the game machine P”. Therefore, the first rule specifies the rule concerning the classification of modality or tense. In the above example, the modality and the tense information in the linguistic expressions of the above example are deleted, and all of them can be categorized in the same topic information of “purchase the game machine P”. Conversely, in the usage to separate the bulletin board to register the comment for the expression indicating a wish such as “I want to purchase the game machine P” and the expression indicating a result of previous purchase such as “I purchased the game machine P”, those information shall not be deleted from the linguistic expression so that different topic information is generated.

The second rule is a rule concerning time in the level of data. For example, if the time information is specified to convert by one week, it is converted as in; Jan. 12, 2007→second week of 2007, Jan. 16, 2007→third week of 2007, and Jan. 19, 2007→third week of 2007. That is, the comment to the text which includes Jan. 12, 2007 as the time information, and the comment to the text including Jan. 16, 2007 as the time information are stored in different bulletin boards (topic information indicating different bulletin boards is generated), however the comment to the specified section text which includes Jan. 16, 2007 and the comment to the text including Jan. 19, 2007 are stored in the same bulletin board (in the range that other linguistic expressions do not differ).

The third rule is a rule concerning a location in the level of data. For example, suppose that the original texts are “fire broke out in Konan-ward, Yokohama-city” and “fire in Midori-ward, Yokohama-city”. The location information obtained by the specified section linguistic analysis means 13 is “Konan-ward, Yokohama-city” and “Midori-ward, Yokohama-city”, respectively, however for the purpose that is not necessary to distinguish in the level of ward, the rule of deleting the information of ward level from the location information to be the topic information is stored in the topic generation policy storage unit 24. As a result, the location information of both texts is “Yokohama-city” that indicate the same bulletin board.

The fourth rule is a rule concerning deletion of information. For example, if the time information is specified to be deleted, for the specified section text of “News updates in May!! Security hole using buffer under-run at email reception found in software XX”, topic information of “software XX→security hole” without the time information is generated. As there are many cases of automatically obtaining the time information at the time of comment registration, and date and time of update of the original document to add a comment thereto in a normal bulletin board, this is effective when there is little need of dividing the comment to be in another bulletin board hourly. This is because that if necessary, users of the bulletin board can mechanically sort and display registration time of the comments and update time of the original document when viewing the comments.

The fifth rule is a rule concerning modes of expression of the topic information. For example, in a case where the mode of expression is specified as the notation by the natural language, the analysis result of “game machine P→use←as a DVD player” generates the topic information of “using game machine P as a DVD player”.

### EXAMPLE 3

The example in the third embodiment is described with reference to FIG. 9.

A blog “game square” includes text; “I just tried playing SACD on the game machine P. However, I am not quite clear about the difference from CD . . . . Come to think of it, I've heard that the game console P can play next generation video. But AA application must be installed on P to do that”

The document section division means 17 reads the text, and divides into multiple specified section texts. In this example, the above text is divided into 3 texts by sentence, which are “I just tried playing SACD on the game machine P.” “Come to think of it, I've heard that the game console P can play next generation video.” “But AA application must be installed on P to do that.”

Next, the specified section linguistic analysis means 13 performs linguistic analysis sequentially to each of the divided text, generates topic information, and the bulletin board management means 15b determines whether there is an existing bulletin board.

In the example of the above text, firstly the specified section topic generation means 14a generates the topic information “playing SACD on the game machine P” from the text “I just tried playing SACD on the game machine P”. Further, the bulletin board management means 15b determines whether a bulletin board having the same topic information exists or not. Since the bulletin board exists, the topic information and the address of the bulletin board are output. As illustrated in FIG. 9, a link to the document including text “Link: Game square” may be displayed on the common bulletin board.

Since there still is an unprocessed divided text, similar processes are performed to the next text of “Come to think of it, I've heard that the game console P can play next generation video”. As there is a bulletin board having the same the topic information “generate next generation video by the game machine P” in the topic information generated from this text, the topic information and an address of the bulletin board are output similarly.

Next, similar processes are performed to the text of “But AA application must be installed to do that . . . ”. The bulletin board of the same topic information does not exist in the topic information “install AA application on the game machine P” generated from this text. Accordingly, the process ends without generating the bulletin board.

The bulletin board management means 15b makes a set of the specified section text and an address to the corresponding bulletin board for the topic information of “playing SACD on the game machine P” and “generate next generation video on the game machine P”, and outputs it as the corresponding bulletin board information. The corresponding bulletin board information is output to the document browser means 11 through the corresponding bulletin board information output means 16.

The document browser provides a link to the bulletin board for the corresponding text part.

According to this example, when a user views the blog 1, the user is able to know the existence of the bulletin board relevant to the contents of the document without specially specifying a section.

### INDUSTRIAL APPLICABILITY

The present invention can be applied to the usage of adding or sharing a comment such as an opinion, a modification, and additional information to a Web and a office document or the like. In an office in particular, it is often the case that there are many documents dealing with a similar content for each department or different versions. In such case, a viewer is able to view all the comments added to the document including similar texts by checking out one document, even without checking out multiple documents.

Moreover, it can be applied to a usage of providing a place to develop an argument through the comments. In order to develop an argument appropriately, more than a certain number of users must participate in the argument, however in the case of the related art 1 and related art 2 where comments are added to each document, viewing users are divided into each document, thus it is difficult to achieve a synergistic effect. However, by using the present invention, comments are shared through the part common to multiple documents or including similar text content (same topic is generated), it is effective for a place to connect users who are viewing different documents.

Moreover, the present invention can be applied to a usage of connecting existing documents or existing bulletin boards that are not directly related with the present invention. The present invention enables to provide an address to a new common bulletin board by the present invention to existing documents or bulletin boards generating the same topic. Accordingly, users of the existing documents and the bulletin boards can know the existence of other documents and bulletin board including the same text, and thereby enabling works as necessary such as elimination, consolidation, and update by each text section in which the addresses to the bulletin boards are returned.

This application is based upon and claims the benefit of priority from Japanese patent application No. 2007-214489, filed on Aug. 21, 2007, the disclosure of which is incorporated herein in its entirety by reference.

### BRIEF DESCRIPTION OF DRAWINGS

FIG. 1 is a block diagram illustrating the configuration of the first embodiment of the present invention;

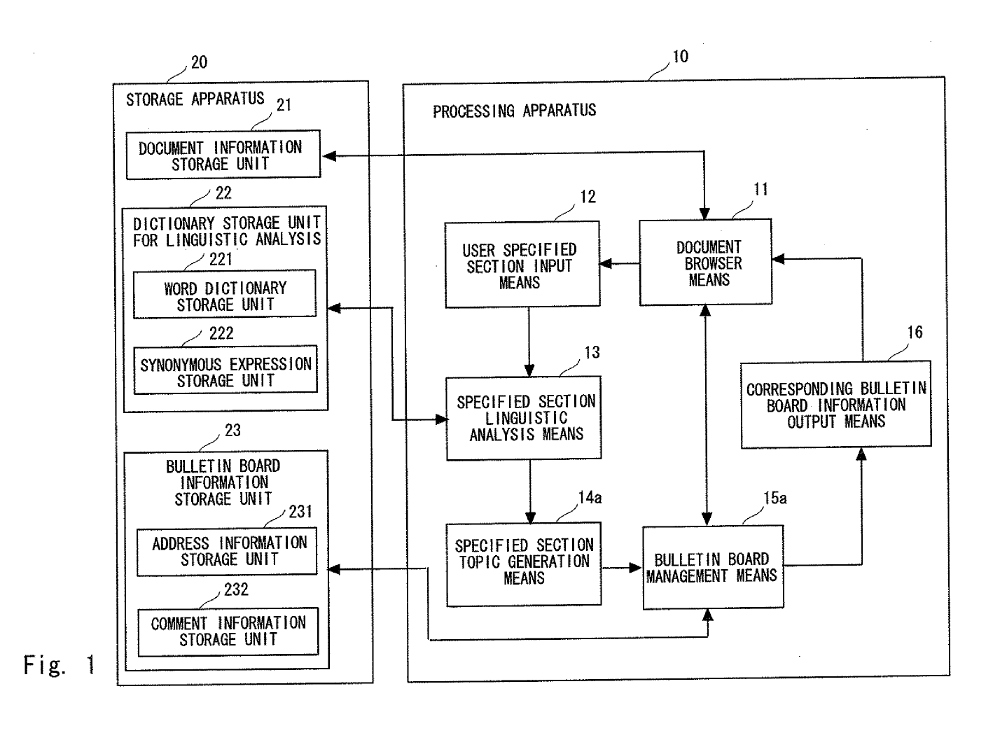

FIG. 2 illustrates examples of linguistic analysis means and corresponding linguistic expression forms used by a specified section linguistic analysis means 13 of the present invention;

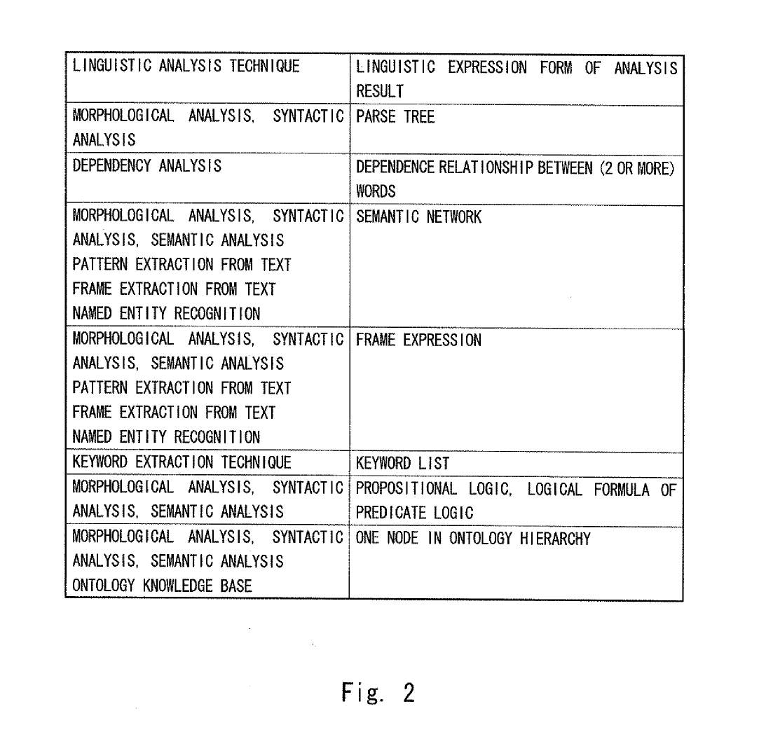

FIG. 3 is a flowchart illustrating an operation of the first embodiment of the present invention;

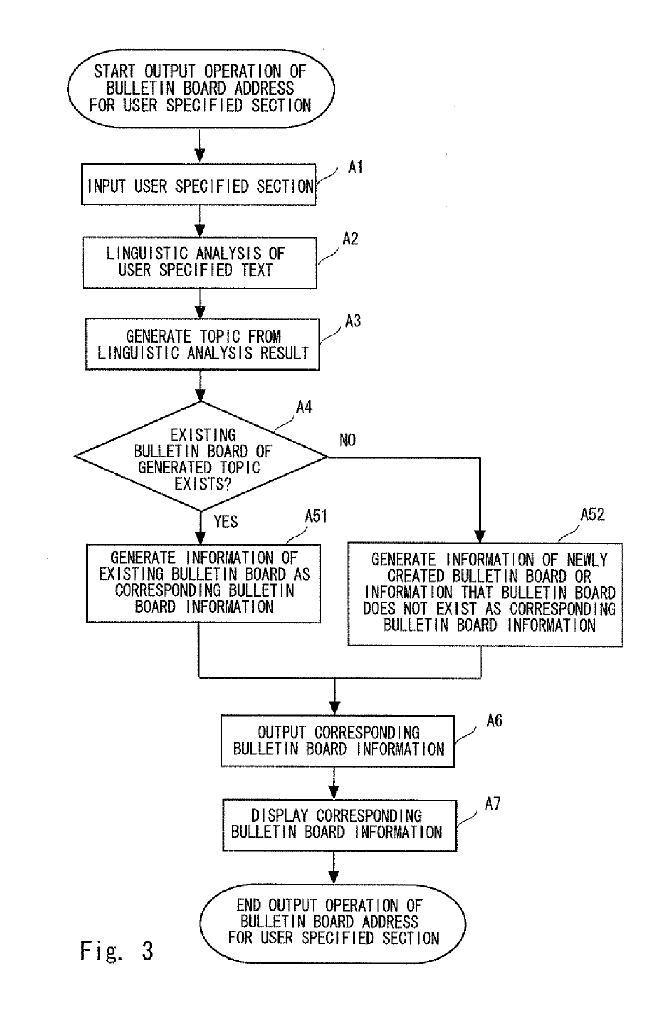

FIG. 4 is a block diagram illustrating the configuration of the second embodiment of the present invention;

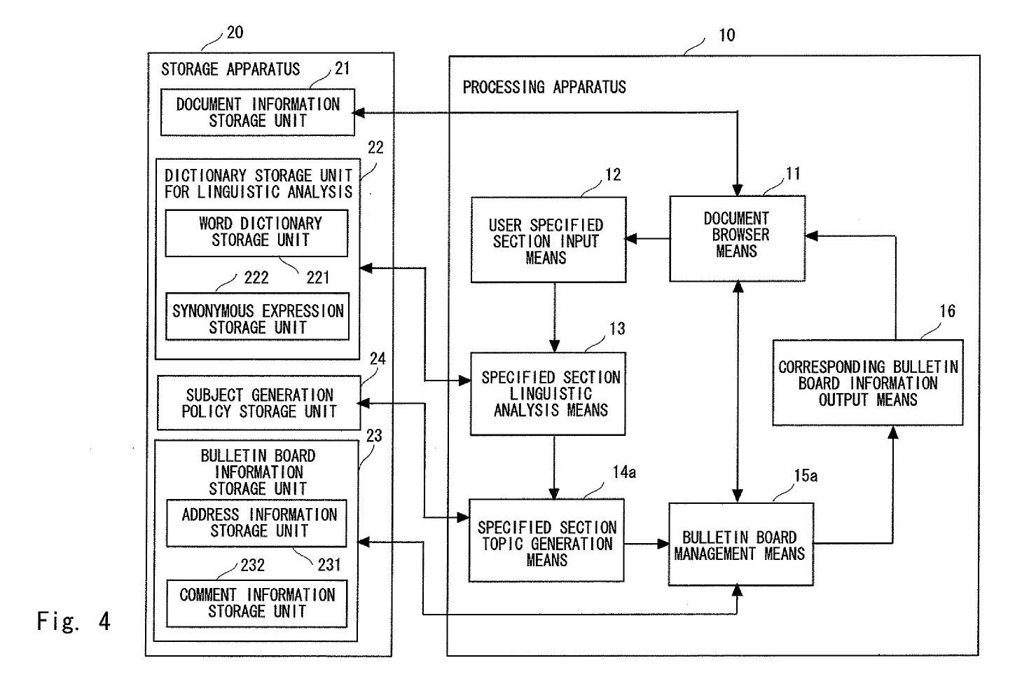

FIG. 5 is a flowchart illustrating an operation of the second embodiment of the present invention;

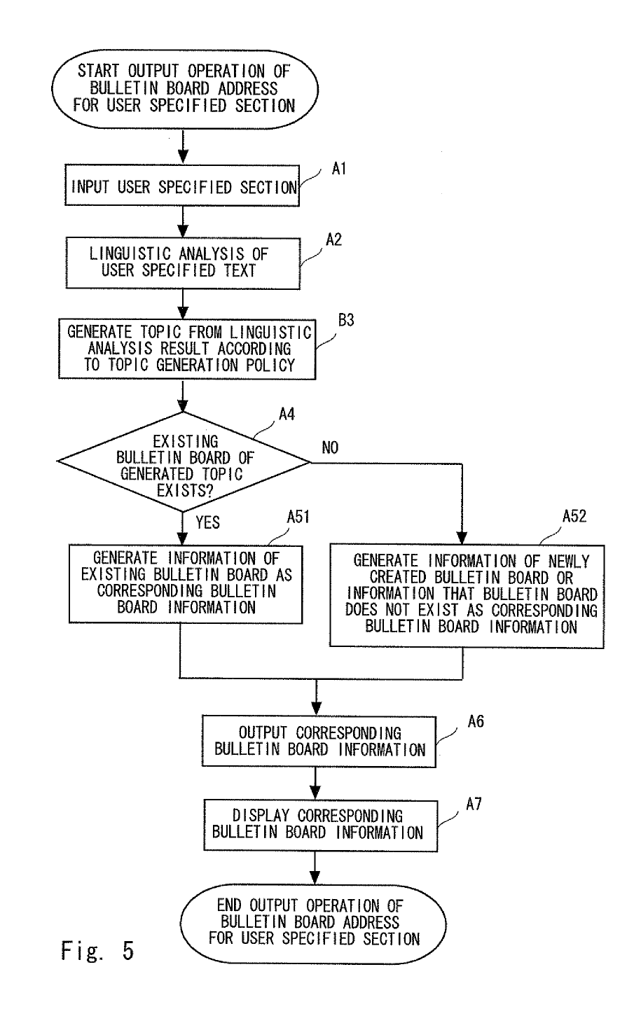

FIG. 6 is a block diagram illustrating the configuration of the third embodiment of the present invention;

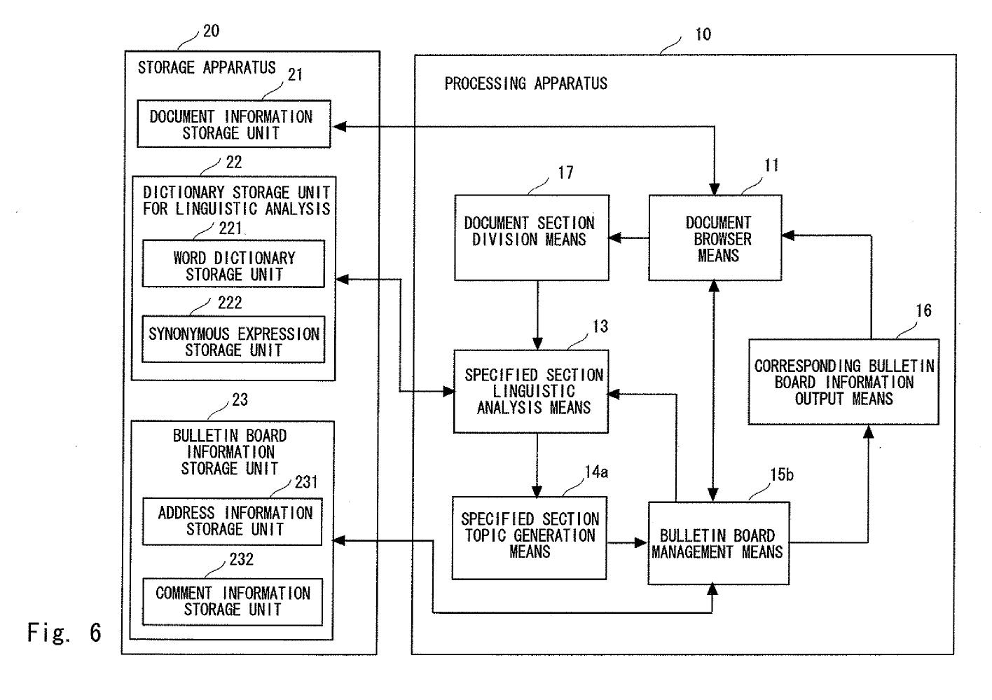

FIG. 7 is a flowchart illustrating an operation of the third embodiment of the present invention;

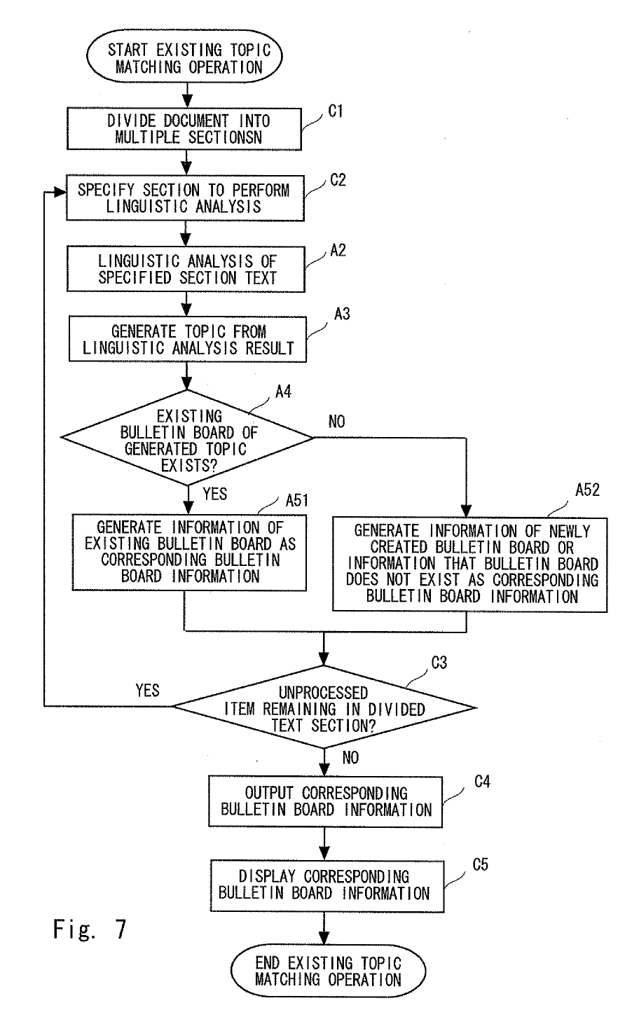

FIG. 8 is a pattern diagram of a first example of the present invention; and

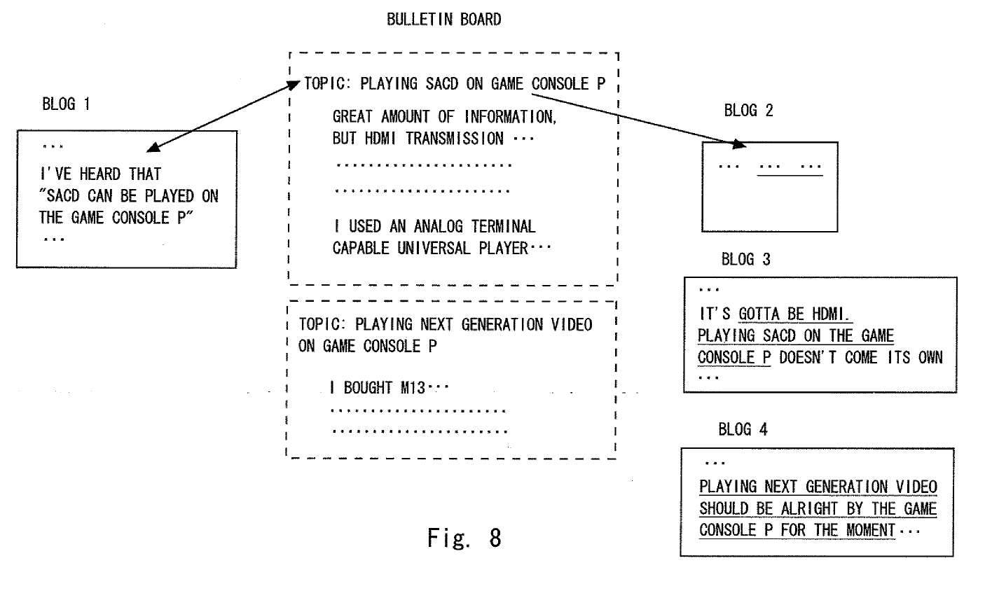

FIG. 9 is a pattern diagram of a third example of the present invention.

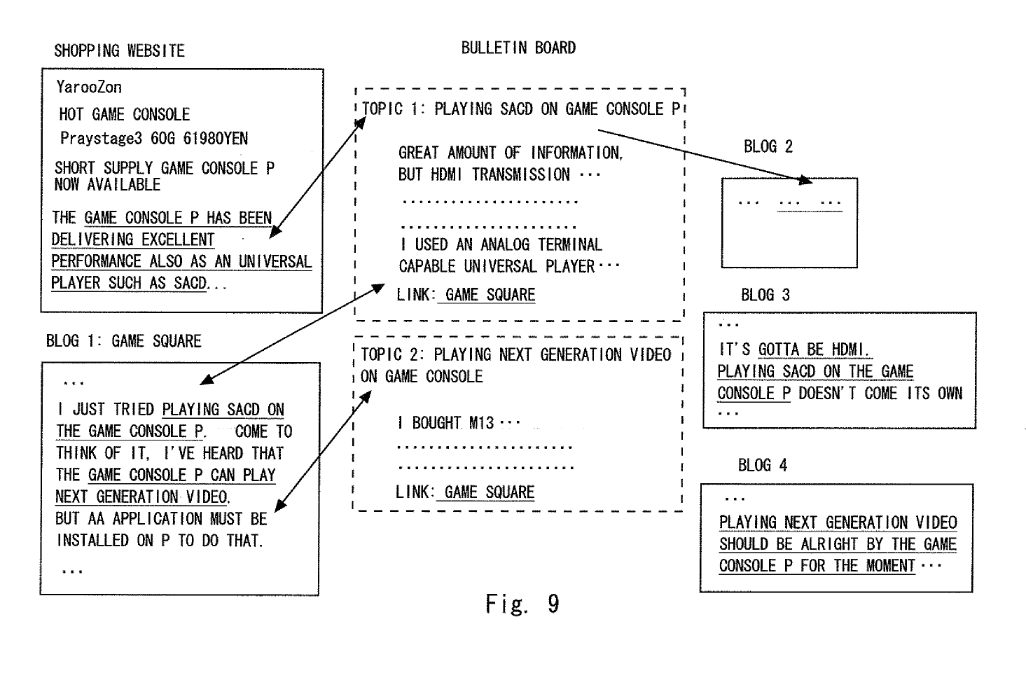

### EXPLANATION OF REFERENCE

10 PROCESSING APPARATUS
11 DOCUMENT BROWSER MEANS
12 USER SPECIFIED SECTION INPUT MEANS
13 SPECIFIED SECTION LINGUISTIC ANALYSIS MEANS
14a, 14b SPECIFIED SECTION TOPIC GENERATION MEANS
15a, 15b BULLETIN BOARD MANAGEMENT MEANS
16 CORRESPONDING BULLETIN BOARD INFORMATION OUTPUT MEANS
17 DOCUMENT SECTION DIVISION MEANS
20 STORAGE APPARATUS
21 DOCUMENTS INFORMATION STORAGE UNIT
22 DICTIONARY STORAGE UNIT FOR LINGUISTIC ANALYSIS
221 WORD DICTIONARY STORAGE UNIT
222 SYNONYMOUS EXPRESSION DICTIONARY STORAGE UNIT
23 BULLETIN BOARD INFORMATION STORAGE UNIT
231 ADDRESS INFORMATION STORAGE UNIT
232 COMMENT INFORMATION STORAGE UNIT
24 TOPIC GENERATION POLICY STORAGE UNIT

1-16. (canceled)

17. An information sharing system comprising:
a specified section linguistic analysis unit that performs a linguistic analysis to a specified section text and outputs linguistic analysis information;
the specified section topic generation unit that refers to a topic generation policy storage unit to generate topic information from the specified section text based on the linguistic analysis information, the topic information indicating a bulletin board to record a comment to the specified section text;
a topic generation policy storage unit that stores a rule for deleting and degenerating information, the information not being distinguished as the topic information in a case that the specified section topic generation unit generates the topic information from the linguistic analysis information of the specified section text;
a topic information storage unit that stores a set of address information of the bulletin board corresponding to each topic information and each topic information, the topic information that has been generated so far by the specified section topic generation unit being an ID; and
a bulletin board management unit that refers to the bulletin board information storage unit and if the address information of the bulletin board indicated by the topic information exists, outputs either one of the address information and a set of the topic information and the address information as corresponding bulletin board information.

18. The information sharing system according to claim 17, wherein if the address information of the bulletin board indicated by the topic information does not exist, the bulletin board management unit newly creates a bulletin board having an ID as the topic information and outputs either one of address information of the created bulletin board and a set of the topic information and the address information of the created bulletin board.

19. The information sharing system according to claim 17, further comprising a user specified section input unit, wherein
the user specified section input unit outputs a text corresponding to section information specified by a user to the specified section linguistic analysis unit as the specified section text.

20. The information sharing system according to claim 17, further comprising a document section division unit, wherein the document section division unit
divides an input text to generate a divided text, and 0
outputs at least one or more of the divided text to the specified section linguistic analysis unit as the specified section text.

21. The information sharing system according to claim 17, further comprising a document browser unit that displays the corresponding bulletin board information that corresponds to the specified section text.

22. A method of sharing information comprising:
a specified section linguistic analysis step that performs a linguistic analysis to a specified section text and outputs linguistic analysis information;
a topic generation policy storage step that stores a rule for deleting and degenerating information, the information not being distinguished as topic information in a case that the specified section topic generation unit generates the topic information that indicates a bulletin board to record a comment to the specified section text from the linguistic analysis information of the specified section text;
a storage step that stores a set of address information of the bulletin board corresponding to each topic information and each topic information to a bulletin board information storage unit, the topic information that has been generated so far in the specified section topic generation step being an ID; and
a bulletin board management step that refers to the bulletin board information storage unit and if the address information of the bulletin board indicated by the topic information exists, outputs either one of the address information and a set of the topic information and the address information as corresponding bulletin board information.

23. The information sharing method according to claim 22, wherein if the address information of the bulletin board indicated by the topic information does not exist, the bulletin board management unit newly creates a bulletin board having an ID as the topic information, stores either one of the address information of the created bulletin board and a set of the topic information and the address information of the created bulletin board, and then outputs it.

24. The information sharing method according to claim 22, further comprising a user specified section input step, wherein
the user specified section input step outputs a text corresponding to section information specified by a user to the specified section linguistic analysis step as the specified section text.

25. The information sharing method according to claim 22, further comprising a document section division step, wherein the document section division step
divides an input text to generate a divided text, and
outputs at least one or more of the divided text to the specified section linguistic analysis step as the specified section text.

26. The information sharing method according to claim 22, further comprising a document browser step that displays the corresponding bulletin board information that corresponds to the specified section text.

27. A recording medium that stores an information sharing program for causing a computer to execute a program comprising:
a specified section linguistic analysis step that performs a linguistic analysis to a specified section text and outputs linguistic analysis information;
a topic generation policy storage step that stores a rule for deleting and degenerating information, the information not being distinguished as topic information in a case that the specified section topic generation unit generates the topic information that indicates a bulletin board to record a comment to the specified section text from the linguistic analysis information of the specified section text;
a storage step that stores a set of address information of the bulletin board corresponding to each topic information and each topic information to a bulletin board information storage unit, the topic information that has been generated so far in the specified section topic generation step being an ID; and
a bulletin board management step that refers to the bulletin board information storage unit and if the address information of the bulletin board indicated by the topic information exists, outputs either one of the address information and a set of the topic information and the address information as corresponding bulletin board information.

28. The recording medium that stores the information sharing program according to claim 27, wherein if the address information of the bulletin board indicated by the topic information does not exist, the bulletin board management unit newly creates a bulletin board having an ID as the topic information, stores either one of address information of the created bulletin board and a set of the topic information and the address information of the created bulletin board, and then outputs it.

29. The recording medium that stores the information sharing program according to claim 27, the information sharing program further comprising a user specified section input step, wherein the user specified section input step outputs a text corresponding to section information specified by a user to the specified section linguistic analysis step as the specified section text.

30. The recording medium that stores the information sharing program according to claim 27, information sharing program further comprising a document section division step, wherein the document section division step
divides an input text to generate a divided text, and
outputs at least one or more of the divided text to the specified section linguistic analysis step as the specified section text.

31. The recording medium that stores the information sharing program according to claim 27, information sharing program further comprising a document browser step that displays the corresponding bulletin board information that corresponds to the specified section text.
